(19) United States
(12) Patent Application Publication
(10) Pub. No.: US 2026/0237153 A1
(43) Pub. Date: Aug. 13, 2026

(54) ELECTRONIC DEVICE, CONTROL METHOD, AND NON-TRANSITORY COMPUTER READABLE STORAGE MEDIUM

(71) Applicant: HTC Corporation, Taoyuan City (TW)

(72) Inventors: Yu-Xiang WANG, Taoyuan City (TW); Tun-Hao CHAO, Taoyuan City (TW)

(21) Appl. No.: 19/051,138

(22) Filed: Feb. 11, 2025

(51) Int. Cl. G06T 17/00; G06T 3/4038; G06T 7/593; H04N 13/00; H04N 13/243; H04N 13/271; H04N 13/296

(52) U.S. Cl. CPC G06T 17/00; G06T 3/4038; G06T 7/596; H04N 13/296; H04N 2013/0081; H04N 13/243; H04N 13/271

(57) ABSTRACT

An electronic device is disclosed. The electronic device includes several first camera circuits, a processor, and a display circuit. The several first camera circuits are configured to capture several images of a real space. The processor is coupled to the several first camera circuits. The processor is configured to: align and merge the several images to create a stitched image; integrate a depth information obtained according to the several images with the stitched image to produce a background image; and create a 3D virtual scene according to the depth information and the background image. The display circuit is coupled to the processor. The display circuit is configured to display a spatial video in the 3D virtual scene.

### FIELD OF INVENTION

The present application relates to an electronic device, a control method, and a non-transitory computer readable storage medium. More particularly, the present application relates to an electronic device, a control method, and a non-transitory computer readable storage medium for recording and displaying a spatial video.

### BACKGROUND

Spatial videos, also known as stereographic 3D videos, provide a more lifelike viewing experience. They offer a rich and dynamic 3D representation of a place and the objects within it.

In current spatial video technologies, the presentation of backgrounds is often limited, which may result in audiences lacking sufficient immersion during viewing. Traditional options include using the current pass-through screen, a randomly selected virtual environment, or allowing the creator to set the background manually. However, these methods may not fully meet audience expectations for realism and interactive experience.

Therefore, how to transform the traditional backgrounds into virtual scenes of spatial videos, enabling users to move within the virtual environment and view the surroundings backgrounds from different angles as they were operating the electronic device, is a problem to be solved.

### SUMMARY

The disclosure provides an electronic device. The electronic device includes several first camera circuits, a processor, and a display circuit. The several first camera circuits are configured to capture several images of a real space. The processor is coupled to the several first camera circuits. The processor is configured to: align and merge the several images to create a stitched image; integrate a depth information obtained according to the several images with the stitched image to produce a background image; and create a 3D virtual scene according to the depth information and the background image. The display circuit is coupled to the processor. The display circuit is configured to display a spatial video in the 3D virtual scene.

The disclosure provides a control method. The control method is suitable for an electronic device including several first camera circuits, a processor and a display circuit. The control method includes the following operations: capturing several images of a real space by the several first camera circuits; aligning and merging the several images to create a stitched image by the processor; integrating a depth information obtained according to the several images with the stitched image to produce a background image by the processor; creating a 3D virtual scene according to the depth information and the background image by the processor; and displaying a spatial video in the 3D virtual scene by the display circuit.

The disclosure provides a non-transitory computer readable storage medium with a computer program to execute aforesaid control method.

It is to be understood that both the foregoing general description and the following detailed description are by examples and are intended to provide further explanation of the invention as claimed.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic block diagram illustrating an electronic device in accordance with some embodiments of the present disclosure.

FIG. 2 is a schematic diagram illustrating a user operating the electronic device in a real space in accordance with some embodiments of the present disclosure.

FIG. 3 is a flowchart illustrating a control method in accordance with some embodiments of the present disclosure.

FIG. 4 is a schematic diagram illustrating an example of the control method as illustrated in FIG. 3 in accordance with some embodiments of the present disclosure.

FIG. 5 is a schematic diagram illustrating an example of displaying a spatial video in the 3D virtual scene in accordance with some embodiments of the present disclosure.

FIG. 6 is a schematic diagram illustrating another example of displaying a spatial video in the 3D virtual scene in accordance with some embodiments of the present disclosure.

FIG. 7 is a schematic diagram illustrating another example of displaying a spatial video in the 3D virtual scene in accordance with some embodiments of the present disclosure.

FIG. 8 is a schematic diagram illustrating an example of displaying a spatial video in the 3D virtual scene from third person perspective in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

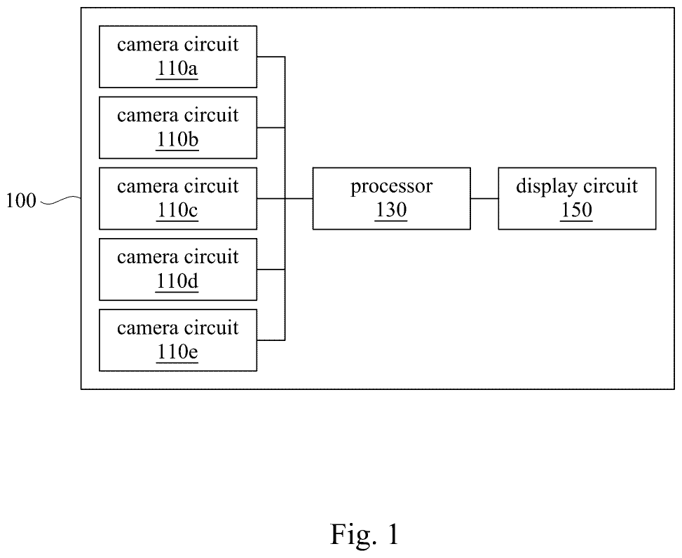

Reference is made to FIG. 1. FIG. 1 is a schematic block diagram illustrating an electronic device 100 in accordance with some embodiments of the present disclosure. As illustrated in FIG. 1, in some embodiments, electronic device 100 includes several camera circuits 110a to 110e, a processor 130, and a display circuit 150. The processor 130 is coupled to the camera circuits 110a to 110e, and the display circuit 150 is coupled to the processor 130. The electronic device 100 as illustrated in FIG. 1 is for illustrative purposes only, and the embodiments of the present disclosure are not limited thereto.

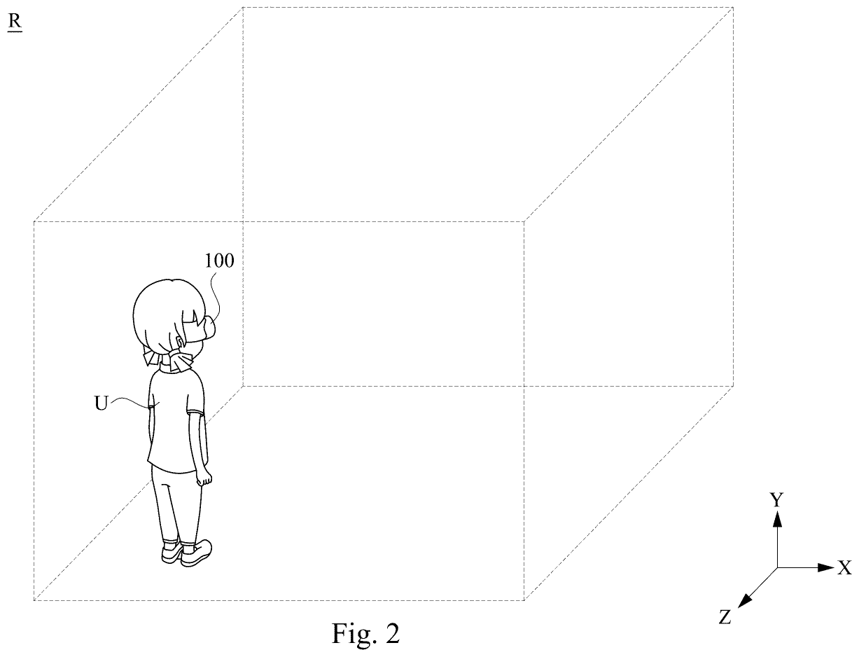

Reference is made to FIG. 2. FIG. 2 is a schematic diagram illustrating a user U operating the electronic device 100 as illustrated in FIG. 1 in a real space R in accordance with some embodiments of the present disclosure.

In some embodiments, the electronic device 100 may be applied in a virtual reality (VR) system or a mixed reality (MR) system. For example, the electronic device 100 may be realized by, a standalone head mounted device (HMD). In some embodiments, the display circuit 150 covers the vision of the user U.

Reference is made to FIG. 1 again. In some embodiments, the electronic device 100 further includes a memory (not shown). One or more programs are stored in the memory and configured to be executed by the processor 130, in order to perform the control method. In some embodiments, the memory includes one or more memory devices, each of which includes, or a plurality of which collectively include a computer readable storage medium. The computer readable storage medium may include a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

In some embodiments, the processor 130 can be realized by, for example, one or more processing circuits, such as central processing circuits and/or micro processing circuits, but are not limited in this regard.

The camera circuits 110a to 110e are configured to capture one or more images of the real space R that the electronic device 100 is operated in. In some embodiments, the camera circuits 110a to 110e may be realized by a camera circuit device or any other camera circuit with image capture functions.

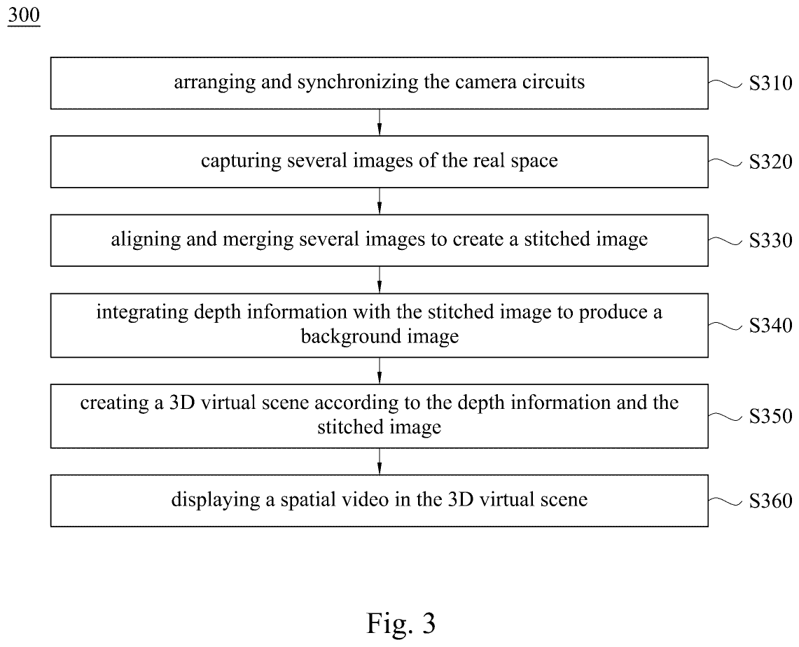

Reference is made to FIG. 3. For better understanding of the present disclosure, the detailed operation of the electronic device 100 will be discussed in accompanying with the embodiments shown in FIG. 3. FIG. 3 is a flowchart illustrating the control method 300 in accordance with some embodiments of the present disclosure. It should be noted that the control method 300 can be applied to an electrical device having a structure that is the same as or similar to the structure of the electronic device 100 shown in FIG. 1. To simplify the description below, the embodiments shown in FIG. 1 will be used as an example to describe the control method 300 according to some embodiments of the present disclosure. However, the present disclosure is not limited to application to the embodiments shown in FIG. 1. As shown in FIG. 3, the control method 300 includes operations S310 to S360.

In operation S310, the camera circuits 110a to 110e as illustrated in FIG. 1 are arranged and synchronized. Reference is made to FIG. 1 together. In some embodiments, the camera circuit with the best specification or with higher specification of the camera circuits 110a to 110c is configured to record the spatial video, while the rest of the camera circuits are configured to capture images or video frames of the background of the real space so as to generate the 3D virtual scene. In some embodiments, the camera circuit with the best specification or with higher specification refers to the camera circuit with the best resolution or shooting capability.

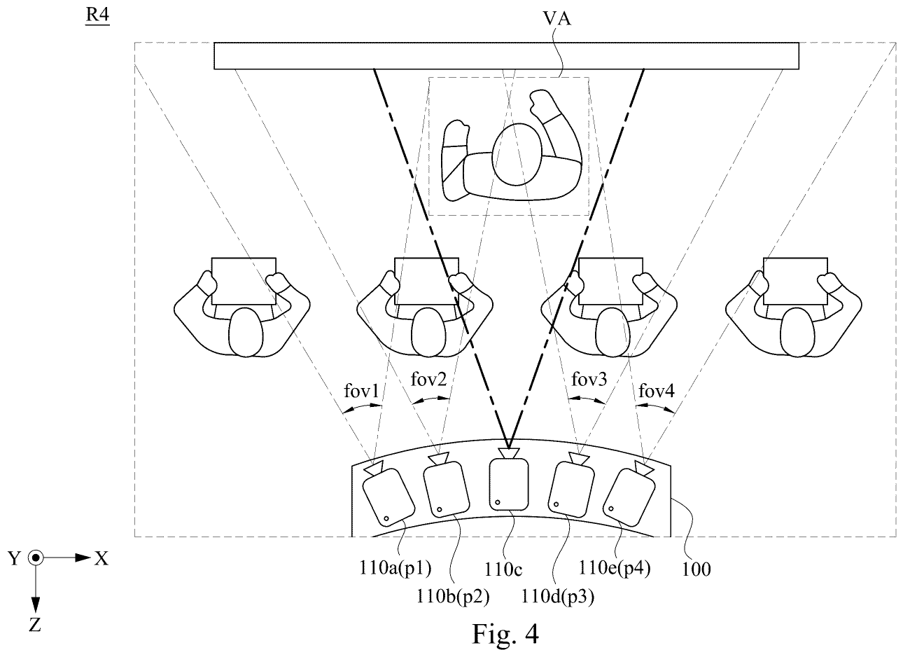

Reference is made to FIG. 4 together. FIG. 4 is a schematic diagram illustrating an example of the control method 300 as illustrated in FIG. 3 in accordance with some embodiments of the present disclosure. Assume that the camera circuit 110c is the camera circuit for recording the spatial video, and camera circuits 110a, 110b, 110d, and 110e are camera circuits for capturing images or video frames of the background of the real space so as to generate the 3D virtual scene.

In some embodiments, the camera circuits 110a, 110b, 110d, and 110e are arranged in a specific configuration to cover a desired large field of view, so as to generate a stitched image with the desired large field of view.

In some embodiments, the camera circuits 110a, 110b, 110d, and 110e are mounted on several preset positions p1 to p4 of the electronic device 100. Each of the camera circuits 110a, 110b, 110d, and 110e covers part of the desired field of view of the stitched image, and the camera circuits 110a, 110b, 110d, and 110e cover the field of view of the stitched image jointly.

For example, as illustrated in FIG. 1, the camera circuit 110a is mounted on position p1 and includes a field of view fov1, the camera circuit 110b is mounted on position p2 and includes a field of view fov2, the camera circuit 110d is mounted on position p3 and includes a field of view fov3, and the camera circuit 110e is mounted on position p4 and includes a field of view fov4. The images of the real space R4 captured by the camera circuits 110a, 110b, 110d, and 110e cover the desired field of view of the stitched image jointly.

In some embodiments, the camera circuits 110a, 110b, 110d, and 110e are arranged in a specific configuration to cover the desired large field of view. This setup might involve placing the camera circuits 110a, 110b, 110d, and 110e in a semi-circle or full-circle arrangement, depending on the required coverage. In some embodiments, the camera circuits 110a, 110b, 110d, and 110e should be mounted on a stable rig to ensure consistent positioning and alignment.

In some embodiments, the camera circuits 110a, 110b, 110d, and 110e are synchronized to capture the images or video frames of the real space R4 simultaneously. In some embodiments, hardware or software solutions such as network time protocol, genlock, and/or precision time protocol are adopted to synchronize the camera circuits 110a, 110b, 110d, and 110e.

In some embodiments, the camera circuits 110a, 110b, 110d, and 110e are set to the same camera parameter. For example, the camera circuits 110a, 110b, 110d, and 110e are set to the same exposure, white balance, and resolution settings to maintain consistency among the captured images.

It should be noted that the number of the camera circuits as illustrated in FIG. 4 is for illustrative purposes only, and the embodiments of the present disclosure are not limited thereto. That is, in some embodiments, the electronic device 100 may include more camera circuits mounted at different positions. In some embodiments, the camera circuits are mounted on the rig of the head mounted device of the electronic device 100, and the camera circuits move along as the user U moves in the real space R4.

In operation S320, several images of the real space are captured by the camera circuits 110a, 110b, 110d and 110e as illustrated in FIG. 1. For example, in FIG. 4, the camera circuits 110a, 110b, 110d and 110e capture images or video frames of the real space R4. Meanwhile, the camera circuit 110c records the spatial video in the area VA.

In some embodiments, the user U may move in the real space R4 during operation S320, and the camera circuits 110a, 110b, 110d and 110e capture images or video frames as the user U moves.

Reference is made to FIG. 3 again. In operation S330, several images captured by the camera circuits 110a, 110b, 110d and 110e as illustrated in FIG. 1 are aligned and merged to create a stitched image by the processor 130 as illustrated in FIG. 1.

In some embodiments, in operation S330, the image stitching software/algorithm is performed by the processor 130 to process the images captured by the camera circuits 110a, 110b, 110d and 110e. The image stitching software/algorithm aligns and merges the images, with the distortions or overlaps corrected.

In some embodiments, the image stitching software/algorithm includes SIFT (Scale-Invariant Feature Transform), SURF (Speeded-Up Robust Features), RANSAC (Random Sample Consensus), Bundle Adjustment, Multi-Band Blending, and Optical Flow. In detail, the SIFT is performed to detect and match the features in the captured images. The SURF is an alternative to SIFT, offering faster performance. The RANSAC is performed for robust alignment by estimating the parameters of a mathematical model from a set of observed data. The Bundle Adjustment is performed to refine camera parameters and minimize re-projection errors. The Multi-Band Blending is performed to seamlessly blend images by reducing visible seams and transitions. The optical flow is performed for stitching video frames to maintain temporal coherence.

The image stitching software/algorithm as mentioned above is for illustrative purposes only, the image stitching software/algorithm is not limited thereto. Any methods for image stitching are within the scope of the embodiments of the present disclosure.

In operation S340, depth information is integrated with the stitched image to produce a background image by the processor 130 as illustrated in FIG. 1. In some embodiments, the camera circuits 110a, 110b, 110d and 110e includes several camera pairs. That is, each two of the camera circuits 110a, 110b, 110d and 110e form a camera pair. For example, reference is made to FIG. 4 together. In some embodiments, the camera circuits 110a and 110b form a camera pair, and the camera circuits 110d and 110e form another camera pair. It should be noted that the camera pair as mentioned above is for illustrative purposes only, and the formation of the camera pair is not limited thereof. For example, in some other embodiments, the camera circuits 110a and 110d form a camera pair, and the camera circuits 110b and 110e form another camera pair.

In some embodiments, in operation S340, the processor 130 analyzes a disparity between the images captured by two camera circuits of the camera pair to obtain the depth information. For example, assume that the camera circuits 110a and 110b form a camera pair, according to the image captured by the camera circuit 110a and the image captured by the camera circuit 110b (which is called the paired images), the processor 130 analyzes the disparity between the image captured by the camera circuit 110a and the image captured by the camera circuit 110b to obtain the depth information.

Several software/algorithm is performed by the processor 130 to obtain the depth information, including stereo image processing, disparity calculation, and depth map creation. The stereo image processing is performed to calculate depth information for each camera pairs, in which the disparities between the paired images are analyzed to estimate the distance of objects in the scene. The disparity calculation algorithms such as the Semi-Global Matching (SGM) or Block Matching (BM) are performed to compute the disparity between the stereo pairs or the paired images. The depth map creation algorithm is performed to convert the disparity data into a depth map, representing the distance of each pixel of the stitched image according to the paired images captured by the camera pairs.

In some embodiments, after the depth information (for example, the depth map) is obtained, the processor 130 integrates the depth information obtained according to the images with the stitched image to produce a background image.

In some embodiments, several software/algorithm is performed by the processor 130 to integrate the depth information with the stitched image to produce the background image. The software/algorithm includes but is not limited to data fusion algorithm and rendering techniques. The data fusion algorithm is performed to combine the depth map with the stitched image (or the real-time stitched image). This integration enhances the visual data with depth cues, making the background image appear more three-dimensional. The rendering technique is performed to seamlessly incorporate the depth data into the visual representation. This may involve creating a mesh according to the depth data/depth information and texturing it with the stitched images.

In operation S350, a 3D virtual scene is created according to the depth information and the stitched image by the processor 130 as illustrated in FIG. 1. In some embodiments, in operation S350, the processor 130 creates several 3D models according to the depth information, and maps the stitched image onto the several 3D models to create the 3D virtual scene.

In some embodiments, several software/algorithm is performed by the processor 130 for operation S350. The software/algorithm includes but is not limited to 3D modeling algorithm, scene layout algorithm, and texture mapping algorithm. The 3D modeling algorithm is performed to construct a 3D virtual environment/a 3D virtual scene using the depth-enriched background image, which is generated according to the depth information and the stitched image. This involves creating 3D models of the 3D virtual scene based on the depth information and applying the stitched image as textures. The scene layout algorithm is performed to design the layout of the 3D virtual scene, ensuring it is navigable and interactive; elements like lighting and shading are incorporated to enhance realism. The texture mapping algorithm is performed to map the stitched image onto the 3D models, ensuring that the textures align accurately with the depth data/depth information.

In operation S360, a spatial video is displayed in the 3D virtual scene by the display circuit 150 as illustrated in FIG. 1. In some embodiments, the processor 130 updates the 3D virtual scene displayed by the display circuit 150 according to a movement of the electronic device 100 in the real space R. In operation S360, when the user U moves to the real space R different from the real space R4 where the spatial video SV is recorded, the user U may view the 3D virtual scene generated according to the images captured at the real space R4.

In some embodiments, a real time rendering algorithm is performed in operation S360. A rendering engine capable of real-time performance to render the 3D virtual environment is performed, which ensures that the 3D virtual scene is updated dynamically based on user interactions. The rendered 3D virtual scene is output by the display circuit 150. In some embodiments, the rendered 3D virtual scene may be output the MR/VR headsets, monitors, or projection systems, providing the user with an immersive experience.

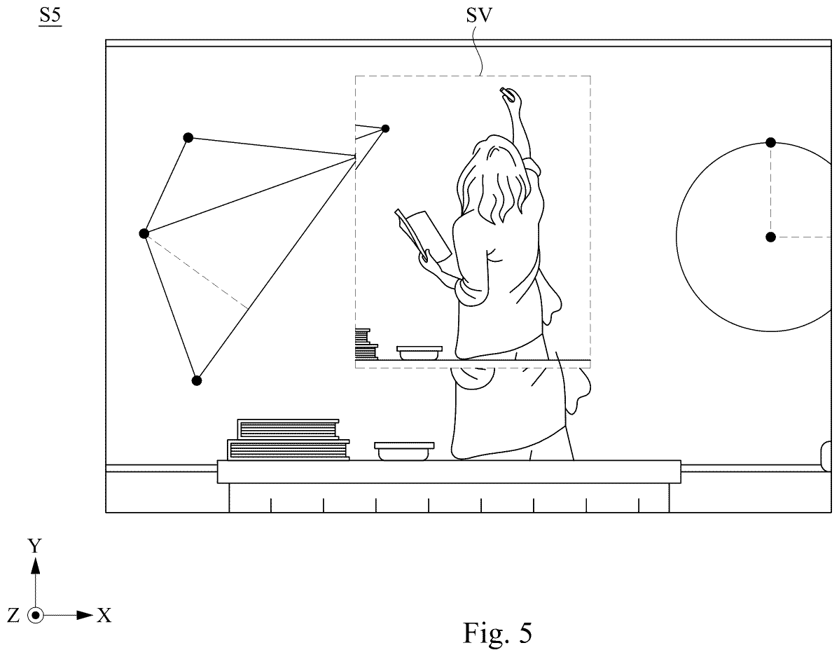

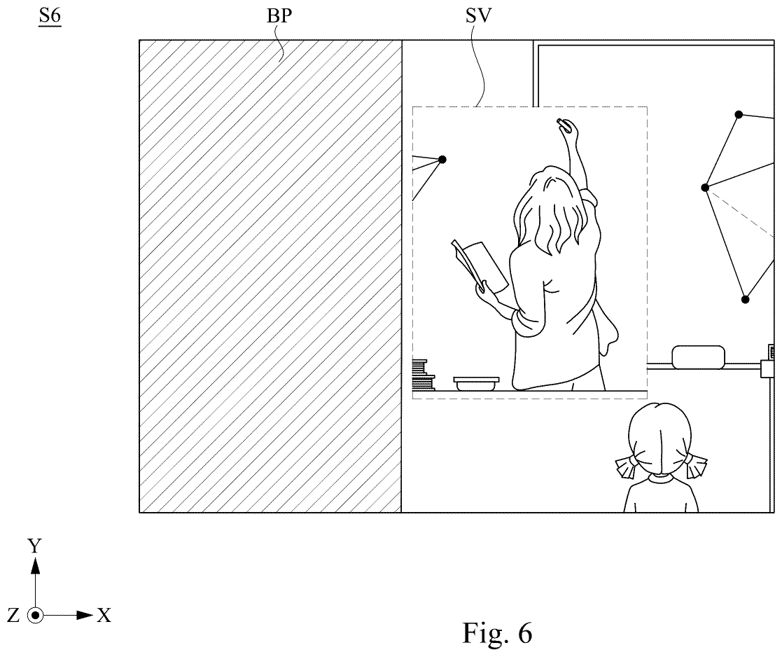

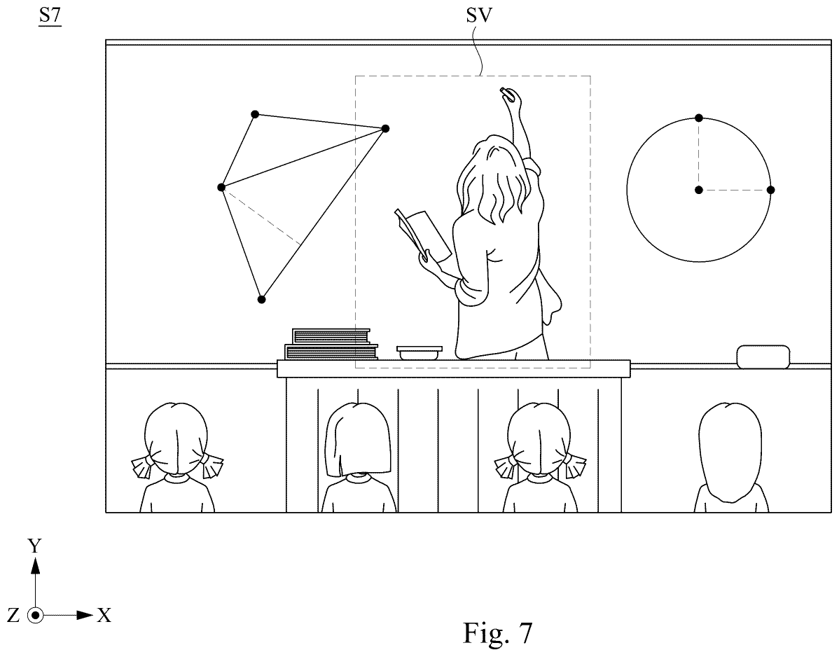

Reference is made to FIG. 5 to FIG. 7 together. FIG. 5 is a schematic diagram illustrating an example of displaying a spatial video SV in the 3D virtual scene S5 in accordance with some embodiments of the present disclosure. FIG. 6 is a schematic diagram illustrating another example of displaying a spatial video SV in the 3D virtual scene S6 in accordance with some embodiments of the present disclosure. FIG. 7 is a schematic diagram illustrating another example of displaying a spatial video SV in the 3D virtual scene S7 in accordance with some embodiments of the present disclosure.

Assume that the spatial video SV with the 3D virtual scene S5 displayed as in FIG. 5 is the initial scene displayed when the user U is operating the electronic device 100 in the real space R as illustrated in FIG. 2. As the user moves among the-X direction, as illustrated in FIG. 6, the 3D virtual scene S6 displayed by the display circuit 150 includes the left part of the stitched image, allowing the user U to view the left part of the blackboard, with the spatial video SV still displayed in the middle of the scene.

As illustrated in FIG. 6, since the stitched image does not includes the image of the blank part BP as illustrated in FIG. 6, as the user U moves among the −X direction, the blank part BP does not show any image on scene of the display circuit 150.

As the user moves among the −Z direction from the initial scene as illustrated in FIG. 5, as illustrated in FIG. 7, the 3D virtual scene S7 displayed by the display circuit 150 includes the whole blackboard, allowing the user U to view the whole blackboard, with the spatial video SV still displayed in the middle of the scene.

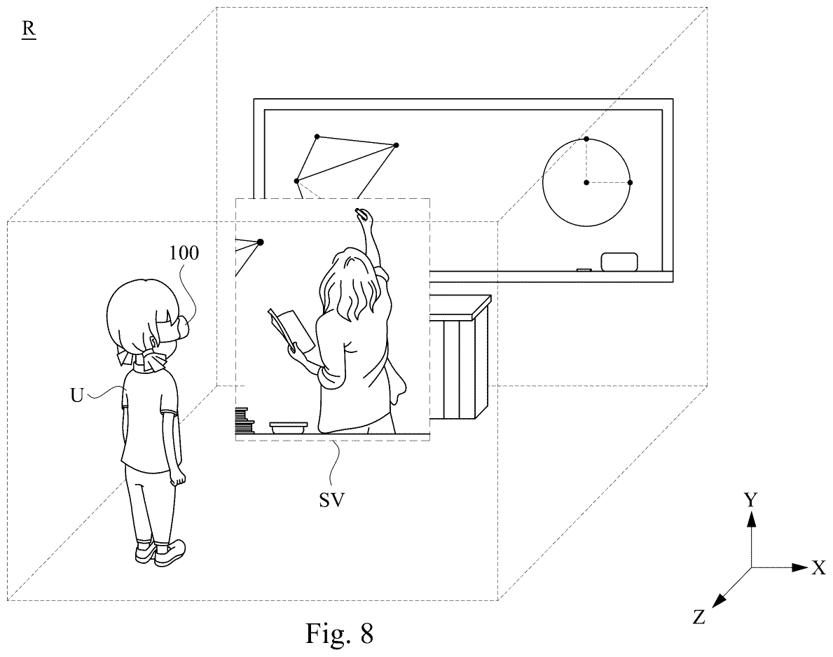

FIG. 5 to FIG. 7 illustrate the scene shown on the display circuit 150 as the electronic device 100 moves with the user U in the real space R. Reference is made to FIG. 8 together. FIG. 8 is a schematic diagram illustrating an example of displaying a spatial video SV in the 3D virtual scene from third person perspective in accordance with some embodiments of the present disclosure. As illustrated in FIG. 8, in the 3D virtual scene created by the processor 130, the spatial video SV may be placed and displayed at any places within the 3D virtual scene created by the electronic device 100 according to the movement of the electronic device 100.

In detail, in the real space R, the blackboard and the table as illustrated in FIG. 8 are the 3D virtual scene created by the electronic device 100, and the electronic device 100 displays the spatial video SV with the 3D virtual scene as the background. The user U may move around in the real space R. Depending on the operating position of the user U, the background displayed on the display circuit 150 may change. For example, the user U can see/not see other students by moving forward or backward, and user U can view different range of the blackboard by moving leftward or rightward.

It should be noted that, in some embodiments, for every frame of the image or the video captured by the camera circuits, the relative stitched image and the 3D virtual scene are generated in real-time by the processor.

Through the operations of various embodiments described above, an electronic device, a control method, and a non-transitory computer readable storage medium are implemented. While recording spatial videos, several synchronized camera circuits are implemented to capture the images of the background, and the images are stitch together to form a stitched image with a large field of view (FOV). The stitched images, paired with depth information generated by stereo camera circuits and the processor, create a deep, stereoscopic 3D background. This method allows us to transform traditional backgrounds into 3D virtual scenes for the background of the spatial videos, enabling users to move within this 3D virtual environment and view the surroundings from different angles as they were during the recording and displaying. This technology provides an immersive experience, making viewers feel as though they are truly present in a more realistic and natural environment. This new approach to background presentation not only enhances viewer immersion but also improves interactive experiences. Viewers are no longer limited to seeing a static background; instead, they can perceive the environment from multiple angles through a panoramic view, making the overall viewing experience richer and more memorable.

In addition, it should be noted that in the operations of the abovementioned control method 300, no particular sequence is required unless otherwise specified. Moreover, the operations may also be performed simultaneously or the execution times thereof may at least partially overlap.

Furthermore, the operations of the control method 300 may be added to, replaced, and/or eliminated as appropriate, in accordance with various embodiments of the present disclosure.

Various functional components or blocks have been described herein. As will be appreciated by persons skilled in the art, the functional blocks will preferably be implemented through circuits (either dedicated circuits, or general purpose circuits, which operate under the control of one or more processing circuits and coded instructions), which will typically include transistors or other circuit elements that are configured in such a way as to control the operation of the circuity in accordance with the functions and operations described herein.

Although the present disclosure has been described in considerable detail with reference to certain embodiments thereof, other embodiments are possible. Therefore, the scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electronic device, comprising:
a plurality of first camera circuits, configured to capture a plurality of images of a real space;
a processor, coupled to the plurality of first camera circuits, wherein the processor is configured to:
align and merge the plurality of images to create a stitched image;
integrate a depth information obtained according to the plurality of images with the stitched image to produce a background image; and
create a 3D virtual scene according to the depth information and the background image; and
a display circuit, coupled to the processor, configured to display a spatial video in the 3D virtual scene.

2. The electronic device of claim 1, wherein the plurality of first camera circuits are synchronized to capture the plurality of images simultaneously, and the plurality of first camera circuits are set to the same camera parameter.

3. The electronic device of claim 1, wherein the plurality of first camera circuits are mounted on a plurality of preset positions of the electronic device, each of the plurality of first camera circuits covers part of a field of view of the stitched image, and the plurality of first camera circuits cover the field of view of the stitched image jointly.

4. The electronic device of claim 1, wherein the plurality of first camera circuits comprise a plurality of camera pairs, wherein a first camera pair of the plurality of camera pairs comprises a first camera circuit and a second camera circuit, wherein the processor is further configured to:
analyze a disparity between a first image captured by the first camera circuit and a second image captured by the second camera circuit to obtain the depth information.

5. The electronic device of claim 1, wherein the processor is further configured to:
create a plurality of 3D models according to the depth information; and
map the stitched image onto the plurality of 3D models to create the 3D virtual scene.

6. The electronic device of claim 1, wherein the processor is further configured to:
update the 3D virtual scene displayed by the display circuit according to a movement of the electronic device in the real space.

7. The electronic device of claim 1, further comprising:
a second camera circuit, configured to record the spatial video when the plurality of first camera circuits are capturing the plurality of images of the real space;
wherein a first specification of the second camera circuit is higher than a second specification of the plurality of first camera circuits.

8. A control method, suitable for an electronic device comprising a plurality of first camera circuits, a processor and a display circuit, wherein the control method comprises:
capturing a plurality of images of a real space by the plurality of first camera circuits;
aligning and merging the plurality of images to create a stitched image by the processor;
integrating a depth information obtained according to the plurality of images with the stitched image to produce a background image by the processor;
creating a 3D virtual scene according to the depth information and the background image by the processor; and
displaying a spatial video in the 3D virtual scene by the display circuit.

9. The control method of claim 8, further comprising:
synchronizing the plurality of first camera circuits to capture the plurality of images simultaneously; and
setting the plurality of first camera circuits to the same camera parameter.

10. The control method of claim 8, further comprising:
mounting the plurality of first camera circuits on a plurality of preset positions of the electronic device, wherein each of the plurality of first camera circuits covers part of a field of view of the stitched image, and the plurality of first camera circuits cover the field of view of the stitched image jointly.

11. The control method of claim 8, wherein the plurality of first camera circuits comprise a plurality of camera pairs, wherein a first camera pair of the plurality of camera pairs comprises a first camera circuit and a second camera circuit, wherein the control method further comprises:
analyzing a disparity between a first image captured by the first camera circuit and a second image captured by the second camera circuit to obtain the depth information.

12. The control method of claim 8, further comprising:
creating a plurality of 3D models according to the depth information; and
mapping the stitched image onto the plurality of 3D models to create the 3D virtual scene.

13. The control method of claim 8, further comprising:
updating the 3D virtual scene displayed by the display circuit according to a movement of the electronic device in the real space.

14. The control method of claim 8, further comprising:
recording the spatial video by a second camera circuit of the electronic device when the plurality of first camera circuits are capturing the plurality of images of the real space;
wherein a first specification of the second camera circuit is higher than a second specification of the plurality of first camera circuits.

15. A non-transitory computer readable storage medium, wherein the non-transitory computer readable storage medium comprises one or more computer programs stored therein, and the one or more computer programs can be executed by one or more processors so as to be configured to operate a control method suitable for an electronic device comprising a plurality of first camera circuits, a processor, and a display circuit, wherein the control method comprises:
capturing a plurality of images of a real space by the plurality of first camera circuits;
aligning and merging the plurality of images to create a stitched image by a processor;
integrating a depth information obtained according to the plurality of images with the stitched image to produce a background image by the processor;
creating a 3D virtual scene according to the depth information and the background image by the processor; and
displaying a spatial video in the 3D virtual scene by the display circuit.

16. The non-transitory computer readable storage medium of claim 15, wherein the control method further comprises:
synchronizing the plurality of first camera circuits to capture the plurality of images simultaneously; and
setting the plurality of first camera circuits to the same camera parameter.

17. The non-transitory computer readable storage medium of claim 15, wherein the control method further comprises:
mounting the plurality of first camera circuits on a plurality of preset positions of the electronic device, wherein each of the plurality of first camera circuits covers part of a field of view of the stitched image, and the plurality of first camera circuits cover the field of view of the stitched image jointly.

18. The non-transitory computer readable storage medium of claim 15, wherein the plurality of first camera circuits comprise a plurality of camera pairs, wherein a first camera pair of the plurality of camera pairs comprises a first camera circuit and a second camera circuit, wherein the control method further comprises:
analyzing a disparity between a first image captured by the first camera circuit and a second image captured by the second camera circuit to obtain the depth information.

19. The non-transitory computer readable storage medium of claim 15, wherein the control method further comprises:
creating a plurality of 3D models according to the depth information; and
mapping the stitched image onto the plurality of 3D models to create the 3D virtual scene.

20. The non-transitory computer readable storage medium of claim 15, wherein the control method further comprises:
updating the 3D virtual scene displayed by the display circuit according to a movement of the electronic device in the real space.
